(19) United States
(12) Patent Application Publication
(10) Pub. No.: US 2023/0132905 A1
(43) Pub. Date: May 4, 2023

(54) BINARY EXECUCTION BY A VIRTUAL DEVICE

(71) Applicant: RED HAT, INC., Raleigh, NC (US)

(72) Inventors: Jesper Brouer, Copenhagen (DK); Michael Tsirkin, Haifa (IL)

(21) Appl. No.: 17/513,442

(22) Filed: Oct. 28, 2021

(51) Int. Cl. G06F 9/455; G06F 8/61

(52) U.S. Cl. CPC G06F 9/45558; G06F 8/62; G06F 2009/45583; G06F 2009/45587

(57) ABSTRACT

Systems and methods for enabling binary execution by a virtual device. An example method may include creating, by a hypervisor running on a host computer system, a virtual device associated with a virtual machine (VM) managed by the hypervisor; receiving, by the hypervisor, a request to offload a binary file from the VM to the virtual device; determining, by the hypervisor, whether a first measurement associated with the binary file matches a stored second measurement; and responsive to determining that the first measurement matches the second measurement, enabling the virtual device to execute the binary file using the host operating system.

### TECHNICAL FIELD

The present disclosure is generally related to virtualized computer systems, and more particularly, to safely executing a binary by a virtual device.

### BACKGROUND

Virtualization herein shall refer to abstraction of some physical components into logical objects in order to allow running various software modules, for example, multiple operating systems, concurrently and in isolation from other software modules, on one or more interconnected physical computer systems. Virtualization allows, for example, consolidating multiple physical servers into one physical server running multiple VMs in order to improve the hardware utilization rate.

Virtualization may be achieved by running a software layer, often referred to as “hypervisor,” above the hardware and below the VMs. A hypervisor may run directly on the server hardware without an operating system beneath it or as an application running under a traditional operating system. A hypervisor may abstract the physical layer and present this abstraction to VMs to use, by providing interfaces between the underlying hardware and virtual devices of VMs.

Processor virtualization may be implemented by the hypervisor scheduling time slots on one or more physical processors for a VM, rather than a VM actually having a dedicated physical processor. Memory virtualization may be implemented by employing a page table (PT) which is a memory structure translating virtual memory addresses to physical memory addresses. Device and input/output (I/O) virtualization involves managing the routing of I/O requests between virtual devices and the shared physical hardware.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level block diagram of an example host computer system that performs memory detection, in accordance with one or more aspects of the present disclosure;

FIG. 2 depicts a block diagram illustrating components and modules of an example computer system, in accordance with one or more aspects of the present disclosure;

FIG. 3 depicts a flow diagram of an example method for enabling binary execution by a virtual device, in accordance with one or more aspects of the present disclosure;

FIG. 4 depicts a block diagram of an example computer system in accordance with one or more aspects of the present disclosure;

FIG. 5 depicts a flow diagram of another example method for enabling binary execution by a virtual device, in accordance with one or more aspects of the present disclosure; and

FIG. 6 depicts a block diagram of an illustrative computing device operating in accordance with the examples of the present disclosure.

### DETAILED DESCRIPTION

Described herein are systems and methods for safely executing a binary by a virtual device. Advances in computer technologies have led to system implementations where the virtual central processing unit (vCPU) of a virtual machine (VM) may become burdened with increasing workloads. In such cases, vCPU utilization can often suffer due to increasing responsibility for performing operations, as well as bottlenecks that can occur when processing data. Instruction offloading (“offloading”) seeks to mitigate these bottlenecks by performing dedicated functions using other resources, such as the host CPU or the CPU of a Peripheral Component Interconnect (PCI) device. A PCI device is an external computer hardware device that connects to a computer system, such as, for example, disk drive controllers, graphics cards, network interface cards (NICs), sound cards, or any other input/output (I/O) device.

A VM may use one or more binary files (“binaries”) to perform computer functions. A binary is an executable or a library file. In some instances, a VM may offload a binary onto a PCI device (e.g., enable the PCI device to execute the binary, rather than the VM). Offloading the binary reduces the software overhead of the VM. For example, a VM may offload a filter (e.g., the Berkeley Packet Filter (BPF)) to a NIC. By enabling the NIC to filter which data packets the VM receives, the host system does not need to wake the VM or have the VM allocate resources for each received data packet. That is, the VM may remain in sleep mode or engaged in performing other tasks for each data packet dropped by the binary filter, thus lowering latency, power consumption, and preventing interruptions to the other tasks processed.

In some instances, the hypervisor may abstract the PCI device by assigning particular port ranges of the PCI device to a VM and presenting the assigned port ranges to the VM as a virtual device. The virtual device may mimic a physical hardware device while existing only in software form. However, the virtual device is generally executed by the operating system of the host system. As such, offloading binaries onto a virtual device exposes the host system to possibly malicious or faulty software (binaries) executed by the virtual device, which is undesirable.

Aspects of the present disclosure address the above-noted and other deficiencies by providing systems and methods of safely executing binaries by virtual devices. In particular, aspects of the present disclosure provide technology that allows a hypervisor to create a virtual device and expose the device to a VM via an appropriate driver. The VM may then request to offload a binary to the virtual device. Responsive to the request, the hypervisor may determine whether the binary is an approved binary for offloading. In particular, the hypervisor may maintain a database of approved binaries. In some embodiments, for each binary, the database may store an associated measurement (e.g., a hash value of the contents of the binary), thus allowing a layer of security to the contents of the database. A hash value is a numeric value of a fixed length that uniquely identifies data. The hypervisor may compare the binary received from the VM to each of the approved binaries stored in the database. For example, the hypervisor may first generate a hash value of the received binary, and compare the generated hash value to each hash value stored on the database. Responsive to the comparison yielding a match (e.g., the generated hash value matches a stored hash value), the hypervisor may allow the virtual machine to offload the binary onto the virtual device, thus enabling the host operating system to execute the binary without involving the resources of the VM. For example, the hypervisor may install the binary file on a host operating system and enable the virtual device to execute the binary file using the host operating system. Alternatively, responsive to the comparison failing to yield a match, the hypervisor may reject the request to offload the binary, at which point, the VM may continue to execute the binary via its associated resources (e.g., the VM's operating system, virtual central processing unit (vCPU), etc.).

Accordingly, aspects of the present disclosure enable the VM to offload a one or more binaries onto a virtual device, thus lowering the latency and power consumption, of the VM, and preventing interruptions to the other tasks processed by the VM.

Various aspects of the above referenced methods and systems are described in details herein below by way of examples, rather than by way of limitation. The examples provided below discuss a virtualized computer system where binary offloading may be initiated by aspects of a hypervisor, a host operating system, a VM, or a combination thereof. In other examples, the memory movement may be performed in a non-virtualized computer system that is absent a hypervisor or other virtualization features discussed below.

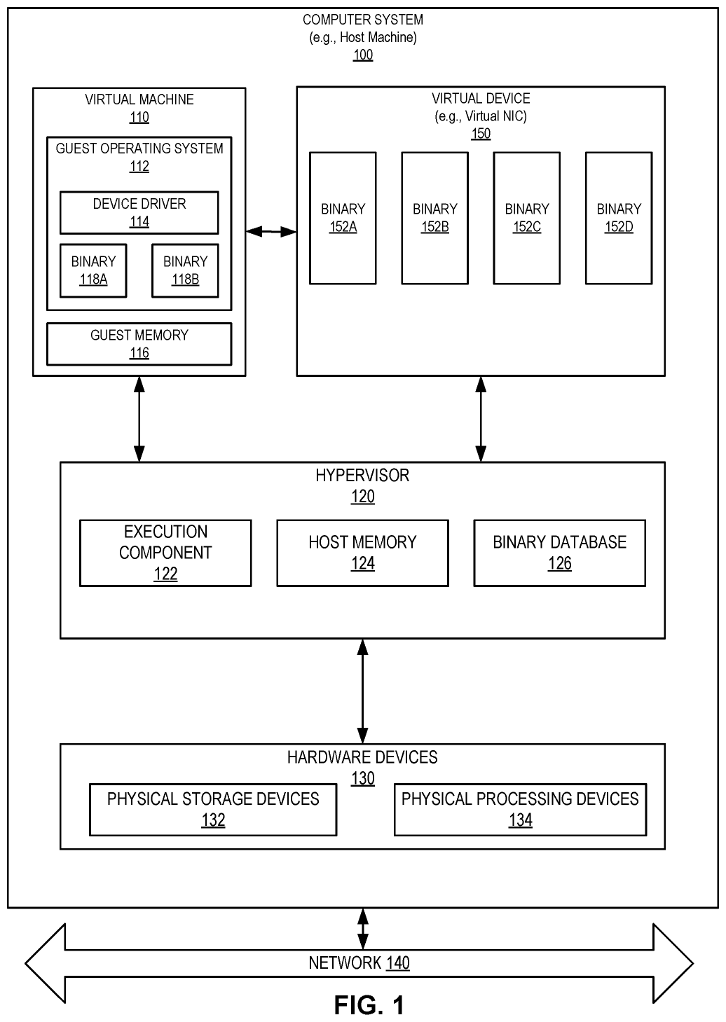

FIG. 1 depicts an illustrative architecture of elements of a computer system 100, in accordance with an embodiment of the present disclosure. It should be noted that other architectures for computer system 100 are possible, and that the implementation of a computing device utilizing embodiments of the disclosure are not necessarily limited to the specific architecture depicted. Computer system 100 may be a single host machine or multiple host machines arranged in a cluster and may include a rackmount server, a workstation, a desktop computer, a notebook computer, a tablet computer, a mobile phone, a palm-sized computing device, a personal digital assistant (PDA), etc. In one example, computer system 100 may be a computing device implemented with x86 hardware. In another example, computer system 100 may be a computing device implemented with PowerPC®, SPARC®, or other hardware. In the example shown in FIG. 1, computer system 100 may include VM 110, hypervisor 120, hardware devices 130, a network 140, and a virtual device 150.

VM 110 may execute guest executable code that uses an underlying emulation of the physical resources. The guest executable code may include a guest operating system, guest applications, guest device drivers, etc. VMs 110 may support hardware emulation, full virtualization, para-virtualization, operating system-level virtualization, or a combination thereof. VM 110 may have the same or different types of guest operating systems, such as Microsoft®, Windows®, Linux®, Solaris®, etc. VM 110 may execute guest operating system 112 that manages device drive 114, guest memory 116, and binaries 118A, 118B.

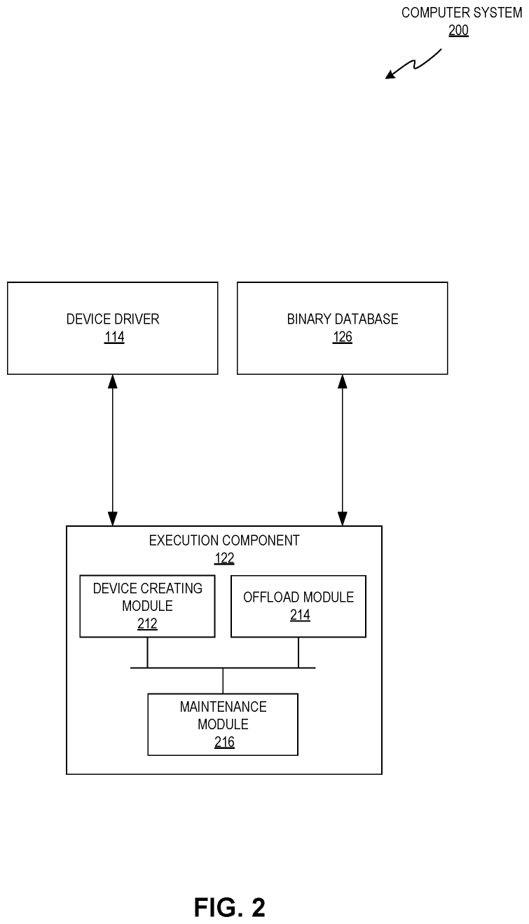

Device driver 114 may be any type of virtual or physical device driver, such as, for example, a vCPU driver. In an example, device driver 114 may be utilized for creating virtual device 150. In another example, device driver 114 may be utilized for communicating with virtual device 150. In another example, device driver 114 may be utilized for requesting hypervisor 120 to offload a binary to virtual device 150. The features provided by device driver 114 may be integrated into the operations performed by guest operating system 112. In some embodiments, device driver 114 may include multiple device drivers enabled to perform the different functions discussed herein. The features of device driver 114 are discussed in more detail below in regards to the computer system of FIG. 2.

Guest memory 116 may be any virtual memory, logical memory, physical memory, other portion of memory, or a combination thereof for storing, organizing, or accessing data. Guest memory 116 may represent the portion of memory that is designated by hypervisor 120 for use by VM 110. Guest memory 116 may be managed by guest operating system 112 and may be segmented into guest pages. The guest pages may each include a contiguous or non-contiguous sequence of bytes or bits and may have a page size that is the same or different from a memory page size used by hypervisor 120. Each of the guest page sizes may be a fixed-size, such as a particular integer value (e.g., 4 KB, 2 MB) or may be a variable-size that varies within a range of integer values. In one example, the guest pages may be memory blocks of a volatile or non-volatile memory device and may each correspond to an individual memory block, multiple memory blocks, or a portion of a memory block.

Binary 118A, 118B may be an executable file that contains executable code represented in specific processor instructions (e.g., machine language or machine code). A binary may include a driver, a core component, a service application, a user tool, a script. Binary 118A, 118B may be executed by guest operating system 112. As will be explained in detail below, binary 118A, 118B may be offloaded by VM 110 to virtual device 150. Once offloaded, binary 118A, 118B may be executed by the host operating system (not shown).

Host memory 124 (e.g., hypervisor memory) may be the same or similar to the guest memory but may be managed by hypervisor 120 instead of a guest operating system. Host memory 124 may include host pages, which may be in different states. The states may correspond to unallocated memory, memory allocated to guests, and memory allocated to hypervisor. The unallocated memory may be host memory pages that have not yet been allocated by host memory 124 or were previously allocated by hypervisor 120 and have since been deallocated (e.g., freed) by hypervisor 120. The memory allocated to guests may be a portion of host memory 124 that has been allocated by hypervisor 120 to VM 110 and corresponds to guest memory 116. Other portions of hypervisor memory may be allocated for use by hypervisor 120, a host operating system, hardware device, other module, or a combination thereof.

Hypervisor 120 (also be known as a VM monitor (VMM)) may provide VM 110 with access to one or more features of the underlying hardware devices 130. In the example shown, hypervisor 120 may run directly on the hardware of computer system 100 (e.g., bare metal hypervisor). In other examples, hypervisor 120 may run on or within a host operating system (not shown). Hypervisor 120 may manage system resources, including access to hardware devices 130. In the example shown, hypervisor 120 may include an execution component 122. Execution component 122 may enable hypervisor 120 to create a virtual device(s) (e.g., virtual device 150), and to offload a binary from virtual machine 110 to the virtual device. Execution component 122 will be explained in greater detail below.

Hypervisor 120 may further include binary database 126. Binary database may be any type of data structure. A data structure may be a collection of data values, the relationships among them, and the functions or operations that can be applied to the data values. Binary database 126 may store a list binaries that virtual machine 110 is allowed to offload onto virtual device 150. In some embodiments, the binaries list may include binaries that are installed on the host machine. In some embodiments, the binaries list may include a predetermined list of approved binaries. In some embodiments, for each approved binary, the binary database 126 may store an associated measurement (e.g., a hash value of the contents of the binary). The binary database 126 may be periodically updated to add and/or remove binaries from the approved binaries list. This will be explained in detail below.

Hardware devices 130 may provide hardware resources and functionality for performing computing tasks. Hardware devices 130 may include one or more physical storage devices 132, one or more physical processing devices 134, other computing devices, or a combination thereof. One or more of hardware devices 130 may be split up into multiple separate devices or consolidated into one or more hardware devices. Some of the hardware device shown may be absent from hardware devices 130 and may instead be partially or completely emulated by executable code.

Physical storage devices 132 may include any data storage device that is capable of storing digital data and may include volatile or non-volatile data storage. Volatile data storage (e.g., non-persistent storage) may store data for any duration of time but may lose the data after a power cycle or loss of power. Non-volatile data storage (e.g., persistent storage) may store data for any duration of time and may retain the data beyond a power cycle or loss of power. In one example, physical storage devices 132 may be physical memory and may include volatile memory devices (e.g., random access memory (RAM)), non-volatile memory devices (e.g., flash memory, NVRAM), and/or other types of memory devices. In another example, physical storage devices 132 may include one or more mass storage devices, such as hard drives, solid state drives (SSD)), other data storage devices, or a combination thereof. In a further example, physical storage devices 132 may include a combination of one or more memory devices, one or more mass storage devices, other data storage devices, or a combination thereof, which may or may not be arranged in a cache hierarchy with multiple levels.

Physical processing devices 134 may include one or more processors that are capable of executing the computing tasks. Physical processing device 134 may be a single core processor that is capable of executing one instruction at a time (e.g., single pipeline of instructions) or may be a multi-core processor that simultaneously executes multiple instructions. The instructions may encode arithmetic, logical, or I/O operations. In one example, physical processing devices 134 may be implemented as a single integrated circuit, two or more integrated circuits, or may be a component of a multi-chip module (e.g., in which individual microprocessor dies are included in a single integrated circuit package and hence share a single socket). A physical processing device may also be referred to as a central processing unit (“CPU”).

Network 140 may be a public network (e.g., the internet), a private network (e.g., a local area network (LAN), a wide area network (WAN)), or a combination thereof. In one example, network 140 may include a wired or a wireless infrastructure, which may be provided by one or more wireless communications systems, such as a wireless fidelity (WiFi) hotspot connected with the network 140 and/or a wireless carrier system that can be implemented using various data processing equipment, communication towers, etc.

Hypervisor 120 may create virtual device 150 and expose virtual device 150 to the VMs via an appropriate virtual device driver 114. Virtual device 150 may have no associated hardware. In some embodiments, virtual device 150 may include an input/output memory management unit (IOMMU), and IOMMU functionality may be implemented by the hypervisor module that communicated with the virtual device driver 114. An IOMMU is a memory management unit (MMU) that resides on the input/output (I/O) path connecting a device to the memory and manages address translations. The IOMMU brokers an incoming DMA request on behalf of an I/O device by translating the virtual address referenced by the I/O device to a physical address similarly to the translation process performed by the MMU of a CPU. Accordingly, the IOMMU of the virtual device 150 may maintain a page table.

The virtual device 150 may include binary 152A-152D. Binary 152A-152D may be execute by the host operating system (not shown), rather that guest operating system 112. In some embodiments, binary 152A-152D may be binaries that were offloaded by VM 110. For example, binary 152A may offloaded binary 118A.

FIG. 2 is a block diagram illustrating example components and modules of computer system 200, in accordance with one or more aspects of the present disclosure. Computer system 200 may comprise executable code that implements one or more of the components and modules and may be implemented within a hypervisor, a host operating system, a guest operating system, hardware firmware, or a combination thereof. In the example shown, computer system 200 may include device driver 114 and hypervisor 122.

Execution component 122 may enable computer system 200 to create a virtual device(s), and offload one more binaries from VM 110 to the virtual device to enhance the performance of VM 110. As illustrated, execution component 122 may include device creating module 212, offloading module 214, and maintenance module 216.

Device creating module 212 may create a virtual device (e.g., virtual device 150) associated with a VM (e.g., VM 110). In an example, device creating module 212 may create virtual device 150 by instructing VM 110 to load device driver 114. Device driver 114 may include executable code to generate virtual device 150. In other embodiments, device driver 114 may request hypervisor 120 to generate virtual device 150. In some embodiments, virtual device 150 may include a page table, may include DMA capabilities, etc. Virtual device 150 may communicate with VM 110 via device driver 114.

Offload module 214 may offload a binary (e.g., binary 118A, 118B) from VM 110 to virtual device 150. In particular, offload module 214 may receive a request from device driver 114 to offload a binary from VM 110 to virtual device 150. Offload module 214 may determine whether the binary is an approved binary for offloading onto virtual device 150. In some embodiments, offload module may compare the binary associated with the offload request to each of the approved binaries stored in binary database 126. The approved binaries may be stored using strings, metadata, measurements (e.g., hash values), or any other comparable form. In one embodiment, offload module 214 may generate a hash value of the binary associated with the offload request. For example, offload module 214 may generate the hash value by applying a hash function to at least part of the binary. Offload module 214 may then compare the generated hash value to each of the hash values stored in binary database 126. If the generated hash value matches a stored hash value, offload module 214 may allow VM 110 to offload the binary onto virtual device 150. For example, offload module 214 may configure virtual device 150 to execute the binary. For example, offload module 214 may install the binary onto the host operating system, and expose or assign the binary to virtual device 150. When invoked by a trigger condition (e.g., a function to be processed by the binary), the binary (e.g., binary 152A, 152B) may execute on the host operating system. If the generated hash value does not match the stored hash value, offload module 214 may reject the offload request from VM 110 to offload the binary onto virtual device 150. As such, VM 110 may continue to execute the binary on guest operating system 112.

By way of illustrative example, VM 110 may operate a packet filter binary. VM 110 may then invoke the hypervisor to generate a vNIC virtual device. Device creating module 212 may create the vNIC by instructing VM 110 to load device driver 114. VM 110 may then request offload module 214 to offload the packet filter onto the vNIC. This would enable the vNIC to process income data packets using the host operating system rather than the guest operating system of the VM, thus lowering the latency and power consumption of VM 110. The offload module 214 may then generate a hash value by applying a hash function to the vNIC associated with the request. The offload module 214 may then compare the generated hash value to the hash values stored on binary database 126. If the generated hash value matches one of the stored hash value, the offload module 214 may offload the packet filter onto the vNIC. Accordingly, the vNIC may then process incoming data packets using the packet filter.

Maintenance module 216 may maintain binary database 126. In some embodiments, maintenance module 216 may receive a set of approved binaries during boot of the host operating system. The set of approved binaries may correlated to executable file or programs provided for use by the host operating system. In some embodiments, maintenance module 216 may list the approved binaries in binary database using strings, metadata, etc. In other embodiments, maintenance module 216 may store, in binary database 126, each approved binary using a measurement value. For example, maintenance module 216 may apply a hash function to each approved binary, and store the generated hash value in binary database 126. In some embodiments, maintenance module 216 may generate the hash value using binary data and security data. The security data may include a salt value (random data used as an additional input), tokens, or any other security type. Accordingly, offload module may use similar security measures when generating a hash value in response to an offload request. In some embodiments, maintenance module 216 may exclude certain binary related data from binary database 126. The excluded data may include metadata, debug data, version data, etc. For example, when generating the hash value for a binary, the metadata, debug data, and/or version data may be excluded. In some embodiments, the hash value may be generate based on only a portion or component of the binary.

Maintenance module 216 may periodically update binary database 126. For example, maintenance module 216 may receive an update file or a patch file. Maintenance module 216 may then add and/or remove binaries from binary database 126 in view of the contents of the update file or a patch file. For example, binary database 126 may include binary 152A-152D. A patch file may indicate that binaries 152A and 152B are to be removed form binary database 126 (this may be due to discovered security issues). Responsive to executing of the patch file, maintenance module 216 may remove the data associated with binaries 152A and 152B from binary database 126. Furthermore, maintenance module 216 may send an instruction to offload module 214 to cease execution of binaries 152A and 152B by the host operating system. Responsive to the instruction, offload module 214 may determine whether a virtual device is executing binary 152A or 152B, and uninstall said binary. Offload module 214 may further send an indication a VM that offloaded binary 152A or 152B that the binary is no longer approved for offloading. Accordingly, the VM may elect to once again execute the binary on the guest operating system.

In some embodiments, maintenance module 216 may maintain allowable versions of the same binary in binary database 126. For example, a packet filter may have three available versions (e.g., version 1, version 2, and version 3). Versions 2 and 3 may be allowable binaries, while version 1 is not. Accordingly, maintenance module 216 may maintain in binary database 126 two separate entries indicating that versions 2 and 3 of the packet filter are allowable (e.g., two distinct hash values).

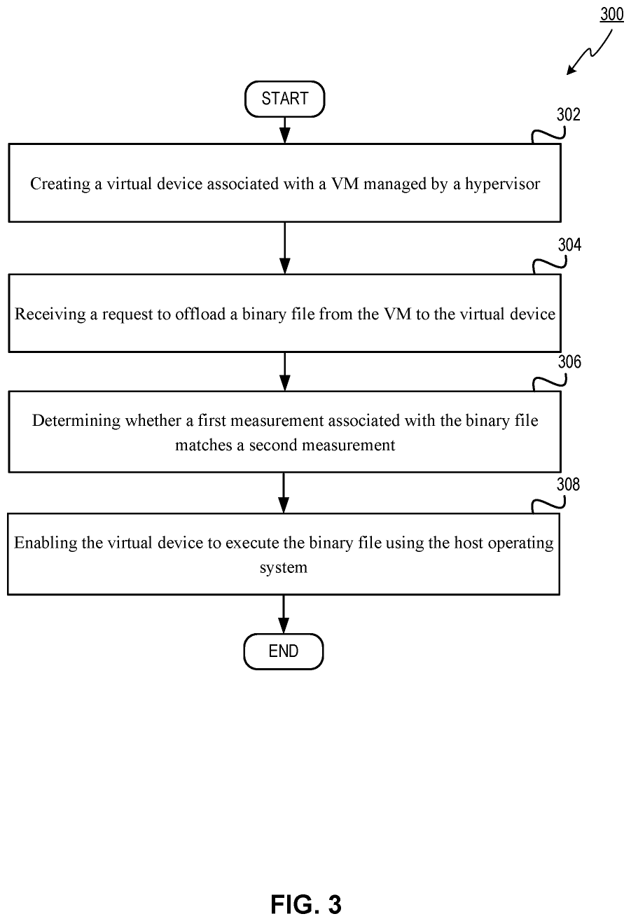

FIG. 3 depicts a flow diagram of an illustrative example of a method 300 for enabling binary execution by a virtual device, in accordance with one or more aspects of the present disclosure. Method 300 and each of its individual functions, routines, subroutines, or operations may be performed by one or more processors of the computer device executing the method. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processes implementing method 300 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 300 may be performed by a kernel of a hypervisor as shown in FIG. 1 or by an executable code of a host machine (e.g., host operating system or firmware), a VM (e.g., guest operating system or virtual firmware), other executable code, or a combination thereof.

Method 300 may be performed by processing devices of a host computer system and may begin at operation 302. At operation 302, a hypervisor running on a host computer system may create a virtual device associated with a VM managed by the hypervisor. The virtual device may include a virtual IOMMU and DMA capabilities (e.g., performs DMA operations.

At operation 304, the hypervisor may receive a request to offload a binary file from the VM to the virtual device. In some embodiments, the binary file may be installed on a host operating system.

At operation 306, the hypervisor may determine whether a first measurement associated with the binary file matches a second measurement. The second measurement may be stored in a database that stores measurement data for each version of the binary. In an example, the hypervisor may generate the first measurement by applying a hash function on the binary file and retrieve the second measurement from a storage location (e.g., binary database 126) storing a set of approved binary files (where each approved binary file is associated with a hash value). The hypervisor may then compare both measurements to determine whether they match. In some embodiments, the hypervisor may exclude metadata associated with the binary file when generating the first measurement.

At operation 308, responsive to determining that the first measurement matches the second measurement, the hypervisor may enable the virtual device to execute the binary file using the host operating system. In some embodiments, responsive to determining that the first measurement does not match the second measurement, the hypervisor may deny the request. In some embodiments, the hypervisor may remove an approved binary file from the database responsive to receiving an update file or a patch file. In some embodiments, responsive to receiving the update file or the patch file to remove the second measurement from the database, the hypervisor may uninstall the binary file from the host operating system. Responsive to completing the operations described herein above with references to operation 308, the method may terminate.

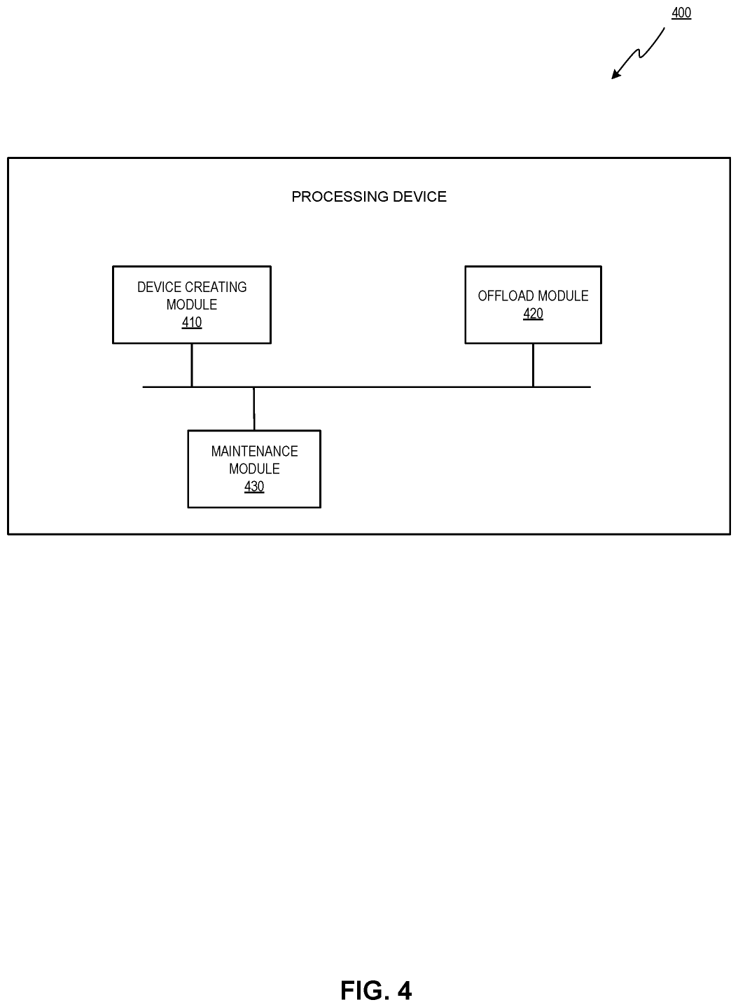

FIG. 4 depicts a block diagram of a computer system 400 operating in accordance with one or more aspects of the present disclosure. Computer system 400 may be the same or similar to computer system 200 and computer system 100 and may include one or more processing devices and one or more memory devices. In the example shown, computer system 400 may include device creating module 410, offloading module 420, and maintenance module 430.

Device creating module 410 may enable a hypervisor running on a host computer system to create a virtual device associated with a VM managed by the hypervisor. The virtual device may include a virtual IOMMU with DMA capabilities.

Offload module 420 may enable the hypervisor to receive a request to offload a binary file from the VM to the virtual device. In some embodiments, the binary file may be installed on a host operating system. Offload module 420 may further enable the hypervisor to determine whether a first measurement associated with the binary file matches a second measurement. The second measurement may be stored in a database that stores measurement data for each version of the binary. In an example, offload module 420 may generate the first measurement by applying a hash function on the binary file and retrieve the second measurement from a storage location storing a set of approved binary files (where each approved binary file is associated with a hash value). Offload module 420 may then compare both measurements to determine whether they match. In some embodiments, offload module 420 may exclude metadata associated with the binary file when generating the first measurement.

Responsive to determining that the first measurement matches the second measurement, offload module 420 may enable the virtual device to execute the binary file using the host operating system. In some embodiments, responsive to determining that the first measurement does not match the second measurement, offload module 420 may deny the request.

Maintenance module 430 may periodically update the database. In some embodiments, the maintenance module 430 may remove an approved binary file from the database responsive to receiving an update file or a patch file. In some embodiments, responsive to receiving the update file or the patch file to remove the second measurement from the database, maintenance module 430 may send an instruction to offload module 420 uninstall the binary file from the host operating system.

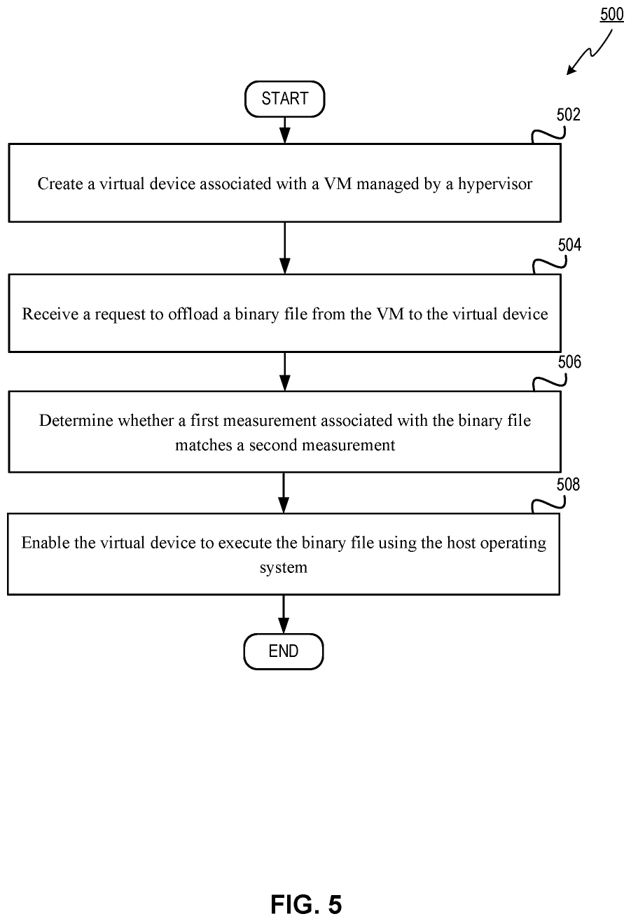

FIG. 5 depicts a flow diagram of one illustrative example of a method 500 for enabling binary execution by a virtual device, in accordance with one or more aspects of the present disclosure. Method 500 may be similar to method 300 and may be performed in the same or a similar manner as described above in regards to method 300. Method 500 may be performed by processing devices of a host computer system and may begin at operation 502.

At operation 502, the processing device may run a hypervisor on a host computer system and create a virtual device associated with a VM managed by the hypervisor. The virtual device may include a virtual IOMMU with DMA capabilities.

In operation 504, the processing device may receive a request to offload a binary file from the VM to the virtual device. In some embodiments, the binary file may be installed on a host operating system.

At operation 506, the processing device may determine whether a first measurement associated with the binary file matches a second measurement. The second measurement may be stored in a database that stores measurement data for each version of the binary. In an example, the processing device may generate the first measurement by applying a hash function on the binary file and retrieve the second measurement from a storage location storing a set of approved binary files (where each approved binary file is associated with a hash value). The processing may then compare both measurements to determine whether they match. In some embodiments, the processing device may exclude metadata associated with the binary file when generating the first measurement.

At operation 508, responsive to determining that the first measurement matches the second measurement, the processing device may enable the virtual device to execute the binary file using the host operating system. In some embodiments, responsive to determining that the first measurement does not match the second measurement, the processing device may deny the request. In some embodiments, the processing device may remove an approved binary file from the database responsive to receiving an update file or a patch file. In some embodiments, responsive to receiving the update file or the patch file to remove the second measurement from the database, the processing device may uninstall the binary file from the host operating system. Responsive to completing the operations described herein above with references to operation 508, the method may terminate.

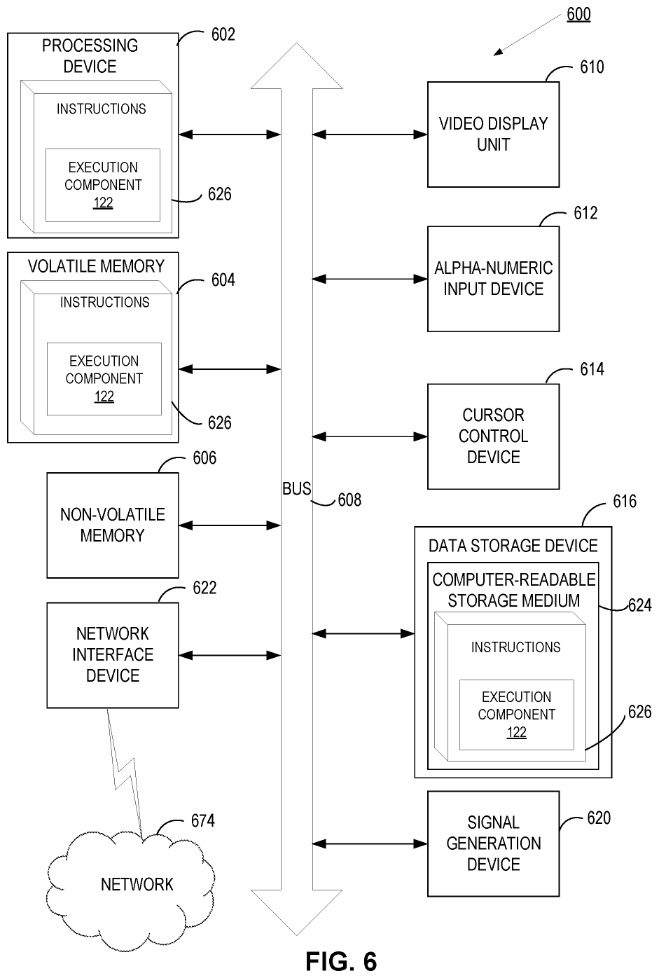

FIG. 6 depicts a block diagram of a computer system operating in accordance with one or more aspects of the present disclosure. In various illustrative examples, computer system 600 may correspond to computing device 100 of FIG. 1 or computer system 200 of FIG. 2. The computer system may be included within a data center that supports virtualization. Virtualization within a data center results in a physical system being virtualized using VMs to consolidate the data center infrastructure and increase operational efficiencies. A VM may be a program-based emulation of computer hardware. For example, the VM may operate based on computer architecture and functions of computer hardware resources associated with hard disks or other such memory. The VM may emulate a physical computing environment, but requests for a hard disk or memory may be managed by a virtualization layer of a computing device to translate these requests to the underlying physical computing hardware resources. This type of virtualization results in multiple VMs sharing physical resources.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions for implementing methods 300 or 500, execution component 122, and modules illustrated in FIGS. 1 and 2.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “initiating,” “transmitting,” “receiving,” “analyzing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods 300 or 500 and one or more of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
creating, by a hypervisor running on a host computer system, a virtual device associated with a virtual machine (VM) managed by the hypervisor;
receiving, by the hypervisor, a request to offload a binary file from the VM to the virtual device;
determining, by the hypervisor, whether a first measurement associated with the binary file matches a stored second measurement; and
responsive to determining that the first measurement matches the second measurement, enabling the virtual device to execute the binary file using the host operating system.

2. The method of claim 1, further comprising:
responsive to determining that the first measurement does not match the second measurement, denying the request.

3. The method of claim 1, wherein determining whether the first measurement associated with the binary file matches the second measurement stored by the hypervisor comprises:
generating the first measurement by applying a hash function on the binary file; and
retrieving the second measurement from a storage location storing a set of approved binary files, wherein each approved binary file is associated with a hash value.

4. The method of claim 1, further comprising:
removing an approved binary file from a database responsive to receiving an update file or a patch file.

5. The method of claim 4, wherein the database stores measurement data for each version of the binary.

6. The method of claim 1, further comprising:
responsive to receiving an update file or a patch file to remove the second measurement from a database, uninstalling the binary file from the host operating system.

7. The method of claim 1, further comprising:
excluding metadata associated with the binary file when generating the first measurement.

8. The method of claim 1, further comprising:
installing the binary file on a host operating system.

9. A system, comprising:
a memory;
a processing device operatively coupled to the memory, the processing device configured to:
create a virtual device associated with a virtual machine (VM) managed by a hypervisor;
receiving a request to offload a binary file from the VM to the virtual device;
determining whether a first measurement associated with the binary file matches a stored second measurement; and
responsive to determining that the first measurement matches the second measurement, enable the virtual device to execute the binary file using the host operating system.

10. The system of claim 9, wherein the processing device is further configured to:
responsive to determining that the first measurement does not match the second measurement, deny the request.

11. The system of claim 9, wherein determining whether the first measurement associated with the binary file matches the second measurement stored by the hypervisor comprises:
generate the first measurement by applying a hash function on the binary file; and
retrieve the second measurement from a storage location storing a set of approved binary files, wherein each approved binary file is associated with a hash value.

12. The system of claim 9, wherein the processing device is further configured to:
removing an approved binary file from a database responsive to receiving an update file or a patch file.

13. The system of claim 12, wherein the database stores measurement data for each version of the binary.

14. The system of claim 9, wherein the processing device is further configured to:
responsive to receiving an update file or a patch file to remove the second measurement from a database, uninstalling the binary file from the host operating system.

15. The system of claim 9, wherein the processing device is further configured to:
exclude metadata associated with the binary file when generating the first measurement.

16. The system of claim 9, wherein the processing device is further configured to:
install the binary file on a host operating system.

17. A non-transitory machine-readable storage medium storing instructions that cause a processing device to:
create a virtual device associated with a virtual machine (VM) managed by a hypervisor;
receiving a request to offload a binary file from the VM to the virtual device;
determining whether a first measurement associated with the binary file matches a stored second measurement; and
responsive to determining that the first measurement matches the second measurement, enable the virtual device to execute the binary file using the host operating system.

18. The non-transitory machine-readable storage medium of claim 17, wherein the processing device is further configured to:
responsive to determining that the first measurement does not match the second measurement, deny the request.

19. The non-transitory machine-readable storage medium of claim 17, wherein determining whether the first measurement associated with the binary file matches the second measurement stored by the hypervisor comprises:
generate the first measurement by applying a hash function on the binary file; and
retrieve the second measurement from a storage location storing a set of approved binary files, wherein each approved binary file is associated with a hash value.

20. The non-transitory machine-readable storage medium of claim 17, wherein the processing device is further configured to:
removing an approved binary file from a database responsive to receiving an update file or a patch file.
